(19) United States
(12) Patent Application Publication
(10) Pub. No.: US 2004/0027384 A1
(43) Pub. Date: Feb. 12, 2004

(54) End-to-end tracing of wavelength parameters in a wavelength division multiplexing span of a fiber optic network

(76) Inventors: Gilbert Levesque, Mountain View, CA (US); Salim Galou, San Jose, CA (US); Youchen Lou, San Jose, CA (US)

Correspondence Address: Michael E. Dergosits, Dergosits & Noah LLP, Suite 1450, Four Embarcadero Center, San Francisco, CA, 94111, US

(21) Appl. No.: 10/218,882

(22) Filed: Aug. 12, 2002

(51) Int. Cl. G09G 5/00

(52) U.S. Cl. 345/771

(57) ABSTRACT

A graphical user interface system for displaying one or more performance characteristics associated with a network span coupling a first network element to a second network element is described. In one embodiment, the system comprises a first display area displaying a performance characteristic related to transmission of a signal over a transmission channel of the first network element to a reception channel of the second network element; and a second display area displaying a counterpart performance characteristic for the reception channel of the second network element, wherein the counterpart performance characteristic measures a change in the performance characteristic after transmission of the signal over the network span.

### FIELD OF THE INVENTION

The present invention relates generally to optical networks, and more specifically to a graphical user interface for displaying wavelength parameters in fiber optic network spans.

### BACKGROUND OF THE INVENTION

Large-scale distributed networks using fiber optic cable have traditionally used time-division multiplexing (TDM) as a means of increasing carrier bandwidth. Throughout the world, telecommunications industries have generally adopted either the Synchronous Optical Network (SONET) or Synchronous Digital Hierarchy (SDH) as standards for optical transport of TDM data. SONET and SDH are two closely related standards that specify interface parameters, rates, framing formats, multiplexing methods, and management for synchronous data over fiber. To increase the bandwidth of these fiber optic network systems over that which is available through TDM, advanced multiplexing schemes, such as Wavelength Division Multiplexing (WDM) are becoming more commonly employed. WDM involves the simultaneous transmission of light from multiple lasers with different wavelengths over a single fiber optic line. These wavelengths of light are transmitted from the sources to a multiplexer that, in turn, consolidates and transmits the resulting signal over the WDM fiber link. In WDM systems, the optical spectrum is separated into channels, each with a different wavelength. Time slots, such as those employed in SONET systems, are then used with each of these channels.

Current WDM systems typically offer up to 32 channels of signals. The higher number of channel wavelengths are typically referred to as Dense Wavelength Division Multiplexing (DWDM) systems. These systems require that the transmission lasers be of very specific wavelengths that are very stable, and have demultiplexers that are capable of distinguishing each wavelength without cross-talk. In general, DWDM systems are defined as WDM systems of greater than four channels, with the channels spaced 2 nm or less from each other.

Typical long-haul optical networks consist of individual network links or spans that are each tens or hundreds of miles long. For such networks, powerful transmission and amplification circuitry is required to ensure proper signal propagation. In a WDM system, special optical amplifiers, usually spaced tens or hundreds of miles apart, amplify all of the transmitted wavelengths simultaneously. The signals are transmitted from a source node through a multiplexer that combines the channels for transmission on the single fiber line. At the receiving node of the WDM link, the received signals are input into a demultiplexer, which separates the signals and transmits them to receivers at the destination point. Various other optical transceiver circuits can affect the signal as it is transmitted along the span. For example, the WDM equipment can also include optical fiber filters that selectively pass or block a particular range of wavelengths, and transponders that function as the transceiver units. Each of these elements can potentially alter or distort the transmitted optical signal in a negative manner.

Because of the tight tolerances required to multiplex and demultiplex WDM and DWDM signals, any shift in wavelength (frequency) of the transmitted signal can cause transmission errors. Various transmission effects can cause such frequency shifts. One such problem is fiber dispersion, which is caused by the fact that each of the frequencies in the transmitted signal has a different characteristic propagation speed. This creates an expansion effect of single short pulses transmitted in high-speed applications, and leads to degradation of the signal and possible bit errors. Other frequency shift affects can be caused by the various amplifier and filter circuits that may be present along the network span.

Most long-haul fiber optic networks are managed by extensive network management systems (NMS) that coordinate and manage the various interface protocols for the network elements and links that comprise the network. Modem large-scale wide area networks (WANs) or metropolitan scale networks (MANs) can consist of thousands of network elements spread over thousands of miles. These network elements, or nodes, are coupled together through a vast number of network links. As stated above, for large-scale fiber optic networks, certain characteristics associated with the transmitted light signals can be affected or unintentionally altered through the course of the network. In general, with regard to WDM networks used in SONET and SDH applications, present NMS interfaces do not provide detailed information regarding the wavelength characteristics of signals transmitted between the network nodes. It is therefore difficult for network operators and designers to determine the nature of signal degradation due to changes in the wavelength or frequency of the optical signals.

Therefore, it is desirable to provide a network management system interface that displays specific wavelength and performance attributes of data signals as they are transmitted between nodes of fiber optic networks.

It is further desirable to provide an interface system that conveniently allows user to view the attributes for multiple channels transmitted among network nodes in a single display instance.

### SUMMARY OF THE INVENTION

A graphical user interface system for displaying one or more performance characteristics associated with a network linear span comprising DWDM capable network elements linked together is described. In one embodiment, the system comprises a first display area displaying a performance characteristic related to transmission channel of the first network element to a reception channel of the second network element; and a second display area displaying a counterpart performance characteristic for the reception channel of the second network element, wherein the counterpart performance characteristic measures a change in the performance characteristic after transmission of the signal over the network span. The first display area can be configured to display the performance characteristic related to transmission in one direction with reference to the first network element, while the second display area can be configured to display a counterpart performance characteristic for the reverse direction with reference to the first network element.

A synchronized scrolling function allows the characteristics for corresponding channels to be displayed coincidentally within the first and second display areas when the total number of available channels exceeds a maximum number that can be displayed in a single display area.

Other features and advantages of the present invention will be apparent from the accompanying drawings and from detailed description that follows.

### BRIEF DESCRIPTION OF THE DRAWINGS

The present invention is illustrated by way of example and not limitation in the figures of the accompanying drawings, in which like references indicate similar elements, and in which:

FIG. 1 is an architectural diagram of an optical network ring that implements a network management system graphical user interface, according to one embodiment of the present invention;

FIG. 2 illustrates an illustrative span of a WDM network that implements a network management system program, according to one embodiment of the present invention;

FIG. 3 illustrates the multiplexing and transmission of data signals in an exemplary four-channel unidirectional WDM span;

FIG. 4 illustrates a graphical user interface display screen for a cross-connect manager program showing exemplary connections created among network elements, according to one embodiment of the present invention;

FIG. 5 illustrates a graphical user interface display screen for an exemplary cross-connect report for a network management system program, according to one embodiment of the present invention;

FIG. 6A illustrates a first part of a wavelength management graphical user interface in which the relevant portion of a network being examined is displayed;

FIG. 6B illustrates a second part of the wavelength management graphical user interface of FIG. 6A in which specific attributes for the network portion are listed;

FIG. 7 illustrates a graphical user interface display screen for viewing wavelength attributes for source and destination nodes of a network link concurrently, according to one embodiment of the present invention; and

FIG. 8 illustrates a graphical user interface display screen for viewing optical power attributes for source and destination nodes of a network link concurrently, according to one embodiment of the present invention.

### DESCRIPTION OF THE PREFERRED EMBODIMENTS

A network management system interface for displaying wavelength characteristics for a large-scale optical network is disclosed. In the following description, for purposes of explanation, numerous specific details are set forth in order to provide an understanding of the present invention. It will be evident, however, to those of ordinary skill in the art that the present invention may be practiced without the specific details. In other instances, well-known structures and devices are shown in block diagram form to facilitate explanation. The description of preferred embodiments is not intended to limit the scope of the claims appended hereto.

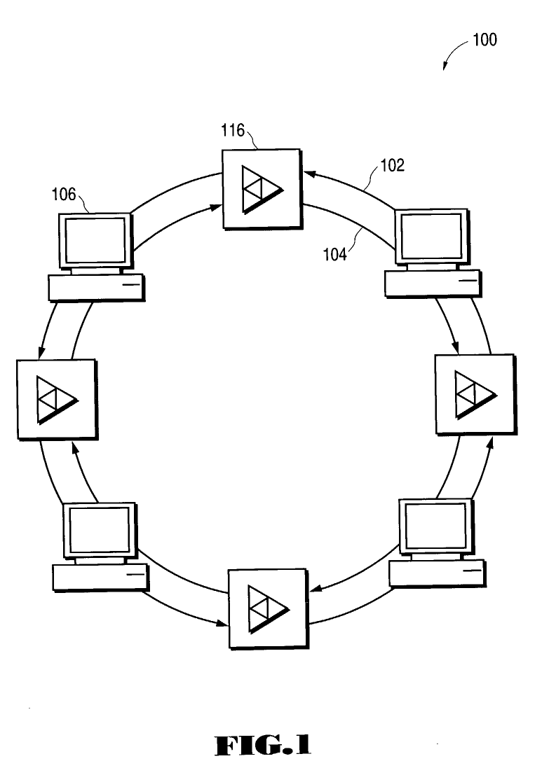

Embodiments of the network management system graphical user interface for WDM networks according to the present invention can be used in a SONET (Synchronous Optical Network) based fiber optic network. SONET networks use two transmission paths between network nodes in a ring configuration. FIG. 1 is an architectural diagram of a SONET ring that can implement a network management system graphical user interface, according to one embodiment of the present invention. The SONET network 100 includes a number of network elements 106 coupled through fiber paths 102 and 104. Each network element is typically implemented as a digital cross-connect system (DCS) or add-drop multiplexer (ADM). The type of device embodied by the network elements 106 depends upon the network environment and application in which the SONET ring is used. For example, an add-drop multiplexer is typically used by telecom carriers to switch and multiplex low-speed voice and data signals onto high-speed lines, and a digital cross-connect is used to switch traffic between multiple SONET links, and serves to link high-speed lines to other high-speed lines.

The ring that connects the nodes 106 together in a SONET network is typically a bi-directional counter-rotating ring. One ring 104 is referred to as the “working” ring, and the other ring 102 is referred to as the “standby” or protection ring. The working ring typically rotates clockwise and the standby ring rotates counter-clockwise around the network. FIG. 1 illustrates a simple UPSR (Unidirectional Path Switched Ring) SONET ring topology comprising a two fiber unidirectional network. In this network, all data is transmitted using the bandwidth of the working path while the standby path is idle. When a failure in the working path occurs, the bandwidth of the standby path is utilized to transmit data. Another common layout for a SONET network is the four fiber bi-directional network in which two separate fiber paths comprise the working ring, and two other separate fiber paths comprise the standby ring. Other SONET network topographies, such as two fiber bi-directional, or four fiber unidirectional networks are also possible, and can be used in conjunction with embodiments of the present invention.

It should be noted that embodiments of the present invention could also be used with other types of optical networks, besides SONET networks. These include networks such as Synchronous Digital Hierarchy (SDH) systems.

In general, optical signals become attenuated as they travel through fiber and must be periodically regenerated in core networks. Traditional Time Division Multiplexing (TDM) SONET networks use repeaters that convert optical signals to electrical signals and back to repeat the signal. For optical networks that employ Wavelength Division Multiplexing (WDM), optical amplifiers are normally used to re-amplify the channels on the fiber. As illustrated in FIG. 1, one or more optical amplifier and/or regenerator elements 116 may be present between each pair of nodes 106 on the network. Because of transmission effects, such as fiber dispersion, and the effects of amplifier and regenerator elements, some degree of wavelength and/or power fluctuation may be present in the transmitted signal. To aid network users and designers in monitoring possible transmission errors due to wavelength and power distortion, a network management system program according to embodiments of the present invention includes graphical user interface display elements that display various transmit and receive wavelength and power related characteristics associated with pairs of network nodes. This allows the user to view any wavelength related distortion effects directly on a single display screen.

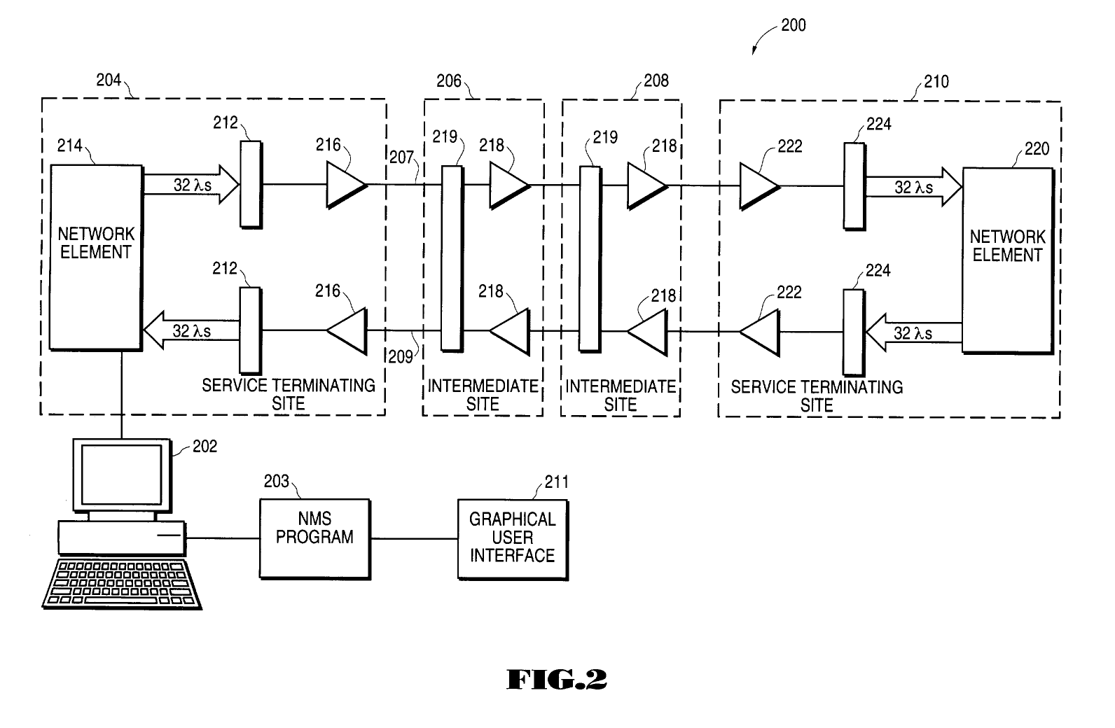

FIG. 2 illustrates an exemplary span of a WDM network that implements a network management system, according to one embodiment of the present invention. In system 200, a first service terminating site 204 is coupled to a second terminating site 210 over two parallel fiber links 207 and 209. Link 207 transmits from site 204 to site 210 and may be characterized as the working line, while link 209 transmits from site 210 to site 204 and may be characterized as the protection or standby line. Service terminating site 204 includes one or more network elements 214 that can transmit and receive up to 32 channels (wavelengths) over the fiber lines 207 and 209. Each channel is assigned a different wavelength. These channels are transmitted or received through optical couplers 212 and pre/post amplifiers 216. Similarly, service terminating site 210 includes one or more network elements 220 that can transmit and receive up to 32 channels. Site 210 includes optical couplers 224 and pre/post amplifiers 222 for transmission or receipt of the signals over lines 207 and 209. Situated between the two service terminating sites 204 and 210 may be one or more intermediate sites 206 and 208. These intermediate sites include network elements 219 and optical amplifiers 218, which serve to amplify the different channels simultaneously for cases in which the distances between sites 204 and 210 are relatively great.

In general, a WDM network span is composed of two terminal WDM systems, such as service terminating sites 204 and 210, and possibly some inline amplifier stages between the terminating sites. Thus, FIG. 2 illustrates a WDM network span comprising two terminating sites with two inline amplifier intermediate sites 206 and 208.

In one embodiment of the present invention, a network management server computer 202 is coupled to the network 200 through one of the service terminating sites, e.g., terminating site 204. The network management server 202 executes a network management system program 203 that controls various aspects of the operation and functionality of the network. The network management system program 203 includes a graphical user interface 211 that consolidates and displays various items of information to the user, and allows the user to monitor and modify aspects of the network operation.

The network management system 203 typically performs various different configuration management tasks, such as remote provisioning of equipment and cross-connects, inventory management, generating reports for network elements, network element synchronization and auditing, among other such tasks. The network management system also provides various performance management features, such as setting and retrieving performance thresholds, reporting of performance measurements and threshold crossing alarms, and other similar tasks. Besides performance and task management functions, the network management system can also perform security and fault management tasks, such as defining security levels based on user profile, generating event-based alarms, alarm severity mapping to cards and facilities, correlating faults to identify affected circuits, and other similar tasks. According to embodiments of the present invention, the network management system program 203 and graphical user interface 211 include modules that determine and display certain wavelength and power related characteristics or attributes of the system 200 to the user.

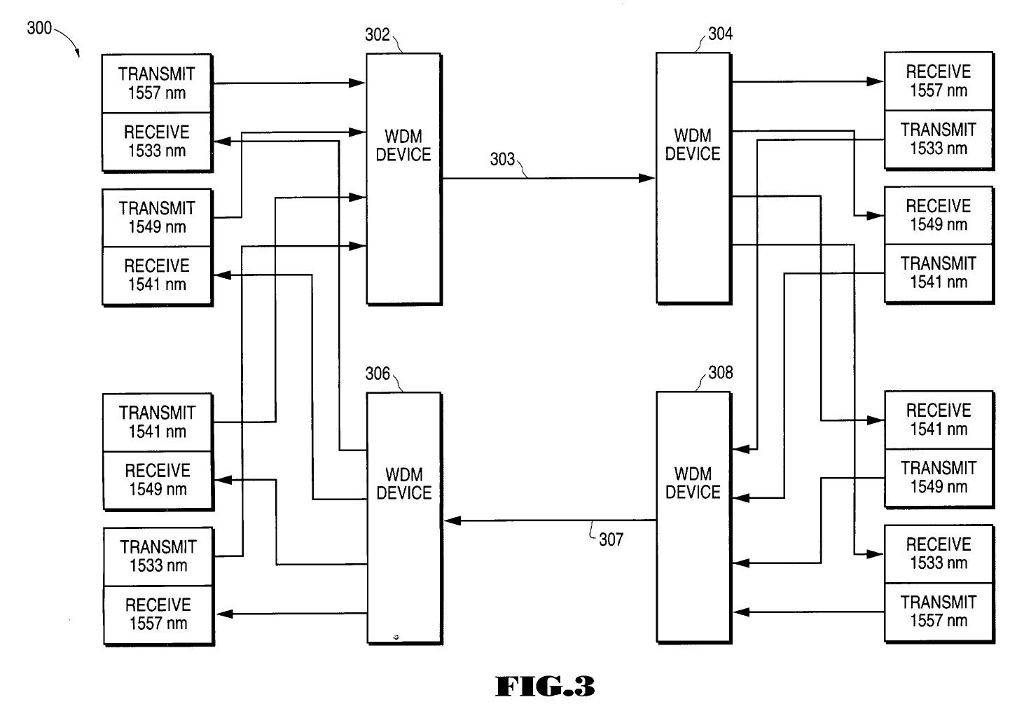

In general, WDM systems may be unidirectional or bidirectional, with a bidirectional device passing a number of multiplexed frequencies in both directions on one fiber. The signal wavelengths for each channel are transmitted from the multiplexer over the fiber and demultiplexed in the receiver circuits at the termination site. For accurate transmission of data, the frequency and wavelength characteristics of each received channel signal should be identical to the characteristics of the signal as transmitted. FIG. 3 illustrates the multiplexing and transmission of signals in an exemplary four-channel unidirectional WDM span. In FIG. 3, four channels of signals are transmitted using the bandwidths of 1533, 1541, 1549, and 1557 nm. These channels are multiplexed for transmission in one direction over the fiber. The four channels are transmitted from WDM device 302 to WDM device 304 over fiber link 303, and from WDM device 308 to WDM device 306 over fiber link 307. As can be seen in system 300, the wavelength of the received signal should match the wavelength of the transmitted signal for each channel. However, due to various transmission and equipment factors, such as dispersion effects, frequency distortion due to optical-electrical conversion, and so on, the frequency between the transmitted and received channel signals may shift slightly.

As illustrated in FIG. 2, the network management system 203 includes a graphical user interface 211 that allows a user to perform most network design and management tasks with point-and-click operations. Various different display screens comprise the graphical user interface. A hierarchy display list can be used to provide rapid navigation between display levels. In one embodiment of the present invention, network elements are displayed against a topological background map, such as a map of North America or Europe. Standardized icons are used to represent different types of network nodes, such as server computers, cross-connects, add/drop multiplexers, and so on.

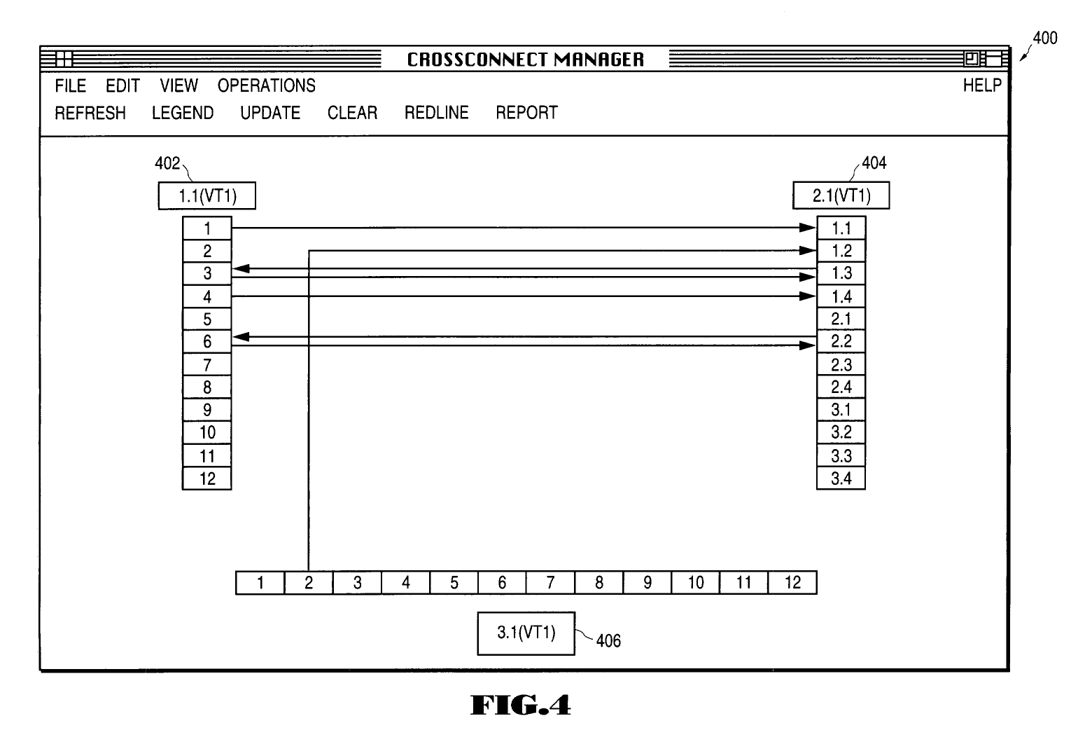

In one embodiment, the NMS graphical user interface 211 displays connectivity and configuration information for the various nodes in the network. For implementations in which network 200 is a SONET network, the network management system 203 includes a cross-connect manager program that displays the cross-connects between SONET STS (Synchronous Transport Signal) or VT (Virtual Tributary) time-slot facilities. FIG. 4 illustrates an exemplary display screen for the cross-connect manager showing connections created among network elements, according to one embodiment of the present invention. The display area 400 features an east-west-south orientation that allows for the display of cross-connects among three separate network nodes. In FIG. 4, these nodes are denoted node 1.1 (VT1) 402, node 2.1 (VT1) 404, and node 3.1 (VT1) 406. The rectangles associated with each node represent time slots or ports (or groups of time slots or ports) for each node. The directional lines connecting the various time slots represent the cross-connects. The graphical user interface illustrated in FIG. 4 facilitates easy display and creation or modification of cross-connects between network nodes.

A cross-connect relates two connection termination points. Traffic is carried between the connection termination points through cross-connects. A SONET cross-connect connects STS or VT time-slot facilities, and can connect a high speed time slot to another high speed time slot, or a low speed time slot to another low speed time slot. A cross-connect has a direction and a rate. The different directions are one-way and two-way, and the different rates are VT1.5/STS1/STS3C/STS12C/STS48C. There can also be special types of cross-connects like the redline cross-connects, service selection cross-connects and bridge cross-connects. As a general rule, only connection termination points of the same rate and type can be cross-connected.

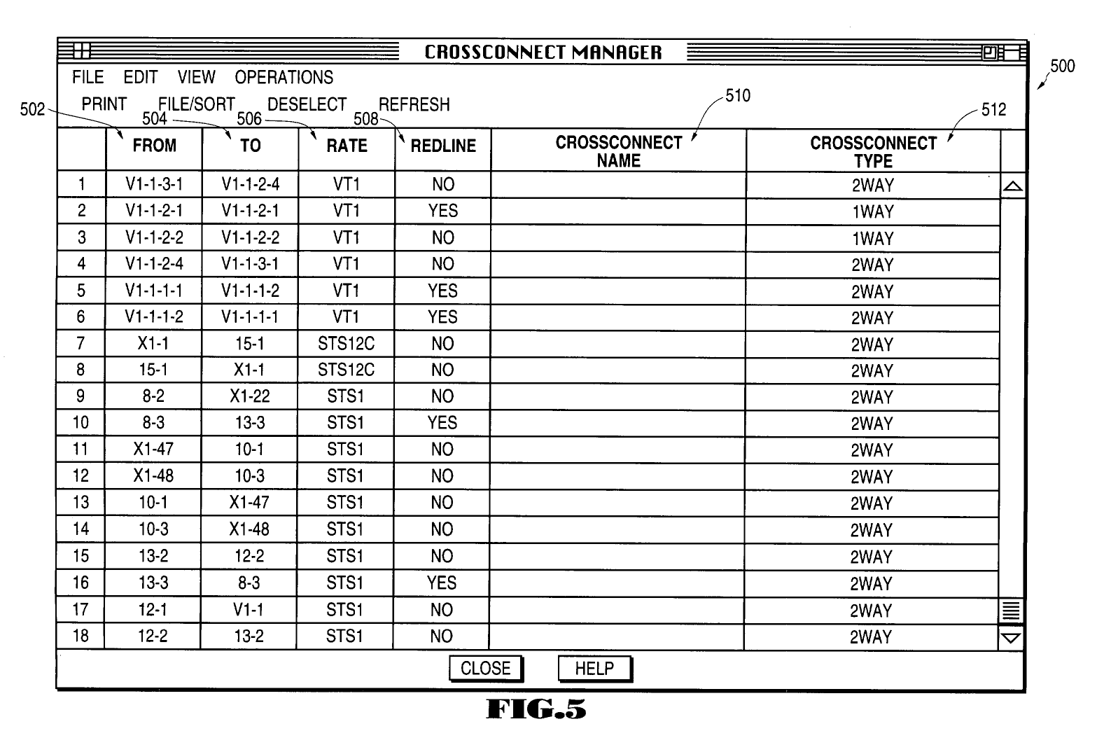

Once cross-connects between network elements have been created, reports can be generated that display relevant information regarding the network links. FIG. 5 illustrates a graphical user interface display screen for an exemplary cross-connect report for a network management system program, according to one embodiment of the present invention. The display screen illustrated in FIG. 5 includes a cross-connect report display area 500. Certain relevant connection information is displayed for a number of channels, e.g., channels 1-18, shown in FIG. 5. This information includes the identity of the source 502 and destination 504 nodes, the rate of the connection 506 for each channel, and the type of connection 512 for each channel. The report screen can also display the name of each cross-connect 510, if such names are defined by the user. The redline entry 508 for each channel indicates whether the cross-connect has been modified by the user through the NMS program. The cross-connect manager report display illustrated in FIG. 5 is intended primarily for purposes of illustration, and many other types of information regarding the network can be compiled and displayed.

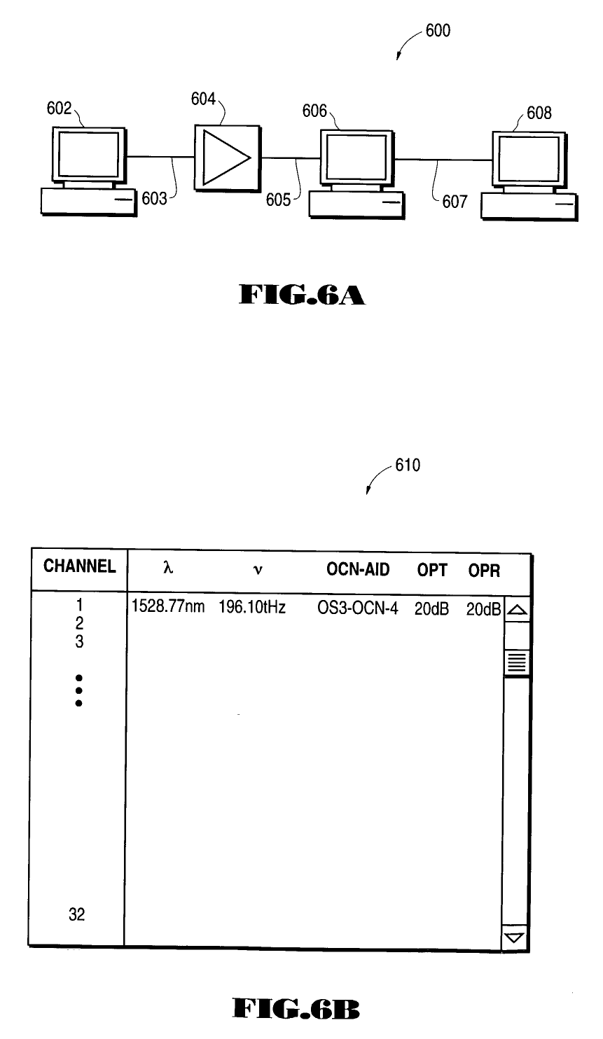

In one embodiment, the network management system program 203 includes a wavelength management process and interface that determines and displays various wavelength characteristics associated with the WDM channels across fiber network spans. FIG. 6A illustrates a first part of the wavelength management graphical user interface in which an example of a relevant portion of the network being examined is displayed. As shown in FIG. 6A, three links, 603, 605, and 607 connect three network terminals 602, 606, and 608 to one another. An amplifier 604 is situated between terminals 602 and 606. An equipment table (not shown) may be displayed to describe the optical component attributes of the network nodes contained in the network link. Depending upon the type of network link that is being examined, network elements 602, 604, 606, 608 can be generally any type of network node, such as a terminal, optical amplifier, repeater, regenerator, multiplexer, router, and other type of optical transmission device that is characterized as a node on the network. For one embodiment, only WDM network elements are displayed on the wavelength management graphical user interface.

FIG. 6B illustrates a second part of the wavelength management graphical user interface in which the specific attributes for the network span illustrated in the first part of the interface are listed. Typically this is provided in tabular form, as shown in table 610. This table lists some relevant optical characteristics for each channel, e.g., channels 1 to 32, along with some exemplary values for these parameters. With regard to wavelength management, the important parameters include the wavelength λ, and frequency v of the transmitted and received signals. Other parameters that can be displayed include the optical carrier number (OCN) and the access identifier (AID) of the source termination point and/or destination termination point, optical power transmitted (OPT), optical power received (OPR), and other such parameters. Besides optical characteristics associated with the transmitted/received signals, certain optical signal noise ratio (OSNR) performance or quality of service (QOS) parameters related to the signals can also be monitored and displayed.

In one embodiment, the graphical user interface 211 is configured to display the relevant attributes for a WDM network span as the signal is transmitted from a source node and received by the destination node. For this embodiment, the network management system program 203 includes a tracing function that determines the value of each relevant attribute for each channel as it is transmitted from the source node, and the corresponding attribute for each channel as it is received by the destination node. For example, the actual wavelength of the signal transmitted on a particular channel is reported by the source node, and the actual wavelength of this signal as received on that channel is reported by the destination node. The corresponding frequency information can be calculated using an operation performed on the measured wavelength data, or it can be determined directly by measurement circuitry in the source and destination nodes. Similarly, other attributes, such as the optical power of the transmitted signal and the optical power of the received signal can be reported by the source and destination nodes can be measured and displayed through the graphical user interface 211.

FIG. 6B illustrates a simplified version of the DWDM attribute display screen in which a single table is displayed within the display area. In a preferred embodiment, multiple tables are displayed concurrently within one display area of the graphical user interface. This allows the user to directly view the correlation of the wavelength related attributes between the source and destination nodes on a WDM link. That is, instead of viewing the attributes for the source node and then viewing the attributes for the destination node on a separate display screen, this information is provided to the user in a single display instance.

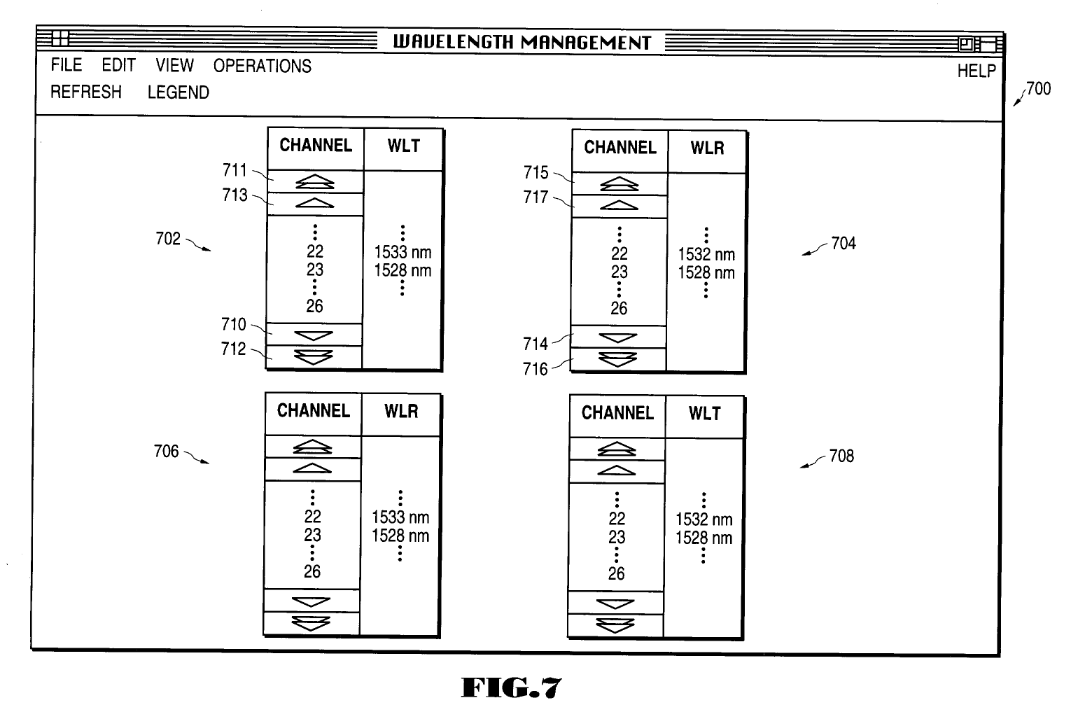

FIG. 7 illustrates the display screen for viewing wavelength attributes for source and destination nodes concurrently, according to one embodiment of the present invention. Table 702 lists the wavelength of signals transmitted (WLT) for each channel from a source node, and table 704 lists the wavelength of signals received (WLR) for the respective channels at the destination node for a pair of network elements. For example, table 702 could represent the attributes for node 602 in FIG. 6A, and table 704 could represent the attributes for node 606. In this case, node 602 is the source node and node 606 is the destination node. As shown in FIG. 7, display screen 700 also includes a second pair of tables, 706 and 708 that list the wavelengths of the transmitted and received channel in the opposite direction, if the link is a bi-directional link.

For the example illustrated in FIG. 7, the wavelength of the transmitted signal on channel 22 from the source node is 1533 nm, and the wavelength of this signal as received on channel 22 at the destination node is 1532 nm. This indicates a shift in wavelength of 1/1000 nm. Similarly, for the return path, table 708 shows the wavelength of the transmitted signal from the source node is 1532 nm, while that of the received signal is 1533 nm. Again this indicates a shift in wavelength. If the two nodes are elements 602 and 606 in FIG. 6A, the shift in frequency between the transmitted and received signals could be due to distortion produced by amplifier 604 between the two nodes.

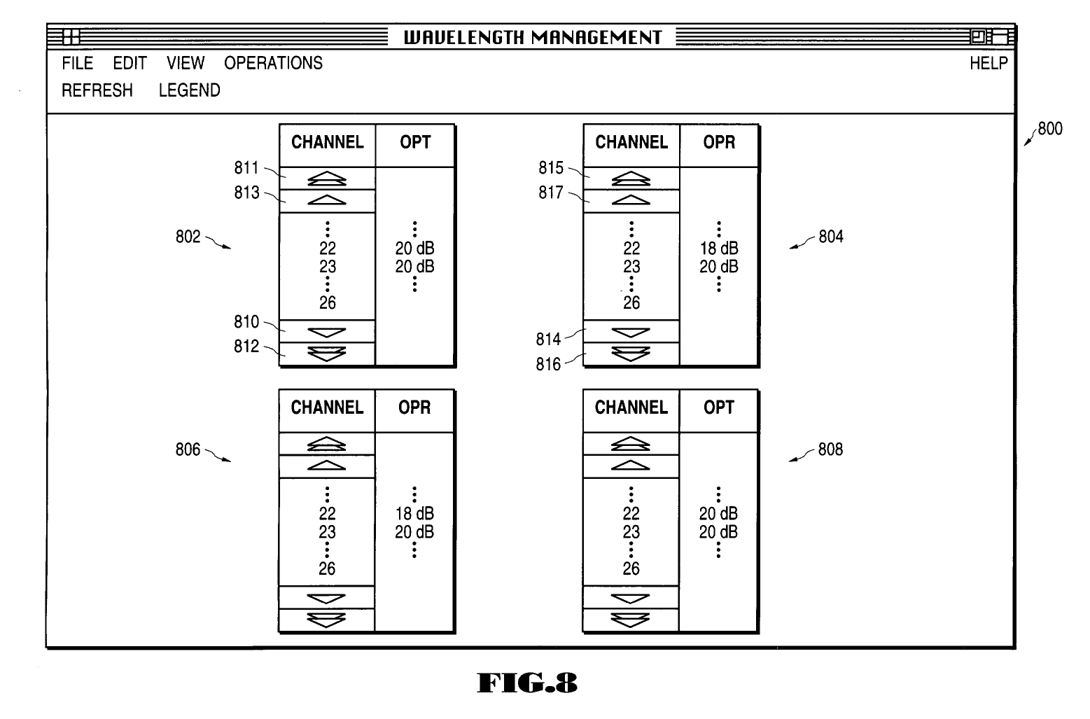

Besides wavelength and frequency, other WDM attributes, frequency-related or otherwise, can be determined and displayed through the graphical user interface. FIG. 8 illustrates the display screen for viewing power attributes for source and destination nodes concurrently, according to one embodiment of the present invention. Table 802 lists the optical power of channels transmitted (OPT) from a source node, and table 804 lists the optical power of the channels received (OPR) at the destination node for a pair of network elements. Display screen 800 of FIG. 8 also includes a second pair of tables, 806 and 808 that list the optical power of the transmitted and received channel in the opposite direction, if the link is a bi-directional link. Thus, for the example illustrated in FIG. 8, the optical power of the transmitted signal on channel 22 from the source node is 20 dB, and the optical power of this signal as received on channel 22 at the destination node is 18 dB. This indicates a 2 dB attenuation in the signal as it is transmitted over the network span. Similarly, for the return path, table 808 shows the optical power of the transmitted signal from the source node is 20 dB, while that of the received signal is 18 dB. The example illustrated indicates some signal attenuation present in the network link. Again, if the two nodes are elements 602 and 606 in FIG. 6A, the power loss between the transmitted and received signals could be due to attenuation produced the network links themselves or by component losses in amplifier 604 between the two nodes.

Although the examples illustrated in FIGS. 7 and 8 show display windows for pairs of nodes, it should be noted that the graphical user interface function is scaleable so that a greater number of attribute tables can be displayed. For example, a further set of tables can be provided so that an additional link is included, and attributes are displayed for three nodes, e.g., 602, 604, and 606, on a single display area. Furthermore, the source and destination nodes can be flexibly defined, rather than simply limited to two adjacent nodes on a single link. Thus, table 702 in FIG. 7 could be defined to be for node 602 in FIG. 6A, and table 704 can be defined to be for node 608. In this manner, the variation of a particular attribute along a link can be measured for a number of intermediate nodes, in this case, amplifier 604 and terminal 606.

Furthermore, the number of channels available across each link can also be scaled. Certain present DWDM systems can provide up to 178 channels on a single fiber. For these systems the number of channels potentially displayed within each single attribute table can be scaled up to 178 channels.

The embodiment illustrated in FIGS. 7 and 8 basically address a scenario in which the variation in a particular attribute is measured with respect to a change in transmission from a first network element to reception in a second network element. It should be noted, however, that the first display area can be configured to display the performance characteristic related to transmission in one direction with reference to the first network element, while the second display area can be configured to display a counterpart performance characteristic for the reverse direction with reference to the first network element.

In one embodiment of the present invention, the graphical user interface includes a synchronized scrolling function for the attribute lists that allows corresponding optical characteristics for source/destination pairs of network elements to be displayed in synchronization with one another. Due to practical space limitations of most computer display terminals, it is often not possible to display the characteristics for all of the channels within a WDM network span in a single display screen. This is especially true if there are a relatively high number of channels, such as 32 or more channels. In this situation, scroll bars are usually employed within the tables, such as that in table 610 of FIG. 6B. This allows the user to scroll up and down the table to find the channel of interest.

Similar scroll bars are included in the tables illustrated in FIGS. 7 and 8. For the embodiment illustrated, scroll bar function buttons are provided for the display channels of each attribute list. As shown in FIG. 7, up and down scroll buttons 713 and 710 are provided to allow the user to scroll the channels, either upwards or downwards, within table 702 one at a time. Fast up and down scroll buttons 711 and 712 are provided to allow the user to continuously scroll through all of the channels. Similar up and down scroll buttons are provided for each of the other tables available in the graphical user interface. For example in table 704, the up scroll buttons 717 and 715, and the down scroll buttons 714 and 716 scroll the displayed channels by either one channel at a time or continuously. With the scroll function, the associated characteristic value, e.g., WLT or WLR value, associated with each channel is scrolled with the respective channel number. It should be noted that FIG. 7 illustrates only one possible configuration of the up and down scroll buttons on the interface. The scroll buttons may be placed within the characteristic value column or adjacent to the table columns, or in a different position with relation to the table.

In one embodiment of the present invention, the user interface includes a scroll synchronization function that couples and synchronizes the scrolling function between pairs of tables for source and destination nodes. This eliminates the need for the user to first scroll the source node table to a particular channel, and then scroll the destination node table to the same channel, which is an especially inconvenient task for networks with a great number of channels, such as, 178 channels. For this embodiment, the graphical user interface includes a scroll synchronization function that couples the scroll function for corresponding pairs of tables together. Thus, for the example illustrated in FIG. 7, with the synchronized scroll function enabled, scroll button 710 would serve to scroll the display in both tables 702 and 704 simultaneously by one channel at a time, and scroll button 712 would serve to continuously scroll the display in both tables 702 and 704 simultaneously. Similarly, scroll buttons 714 and 716 in table 704 would scroll the display in both tables 704 and 702 simultaneously. Using this function, the transmit and receive wavelength for any channel can be easily found for the pair of source and destination nodes.

In an alternative embodiment, the synchronized scroll function can be configured to scroll all of the tables within a WDM span. Thus, for the interface illustrated in FIG. 7, the scroll buttons associated with table 702 can be configured to concurrently scroll the channels for all of the tables 702, 704, 706, and 708. This allows all of the attributes for a specific channel or group of channels to be easily accessed and displayed simultaneously.

As shown in FIG. 8, analogous scroll buttons 810-817 are available for other attribute tables provided by the network management system. These scroll buttons can be configured to scroll the channels and associated characteristics in each table independently or for multiple tables in a synchronous manner, as described above with reference to FIG. 7.

Although FIGS. 7 and 8 illustrated an embodiment in which tables were provided for a particular source and destination pair of network elements, if the display area is large enough, attribute tables for greater than two nodes in the WDM span may be shown. In this case, the synchronized scrolling feature may be used to access and display the attributes for particular channels among a plurality (or all) of the nodes in a WDM span.

In one embodiment, the attribute lists, e.g., 702 and 704 are constructed as simple data structures within the network management system program 203. The graphical user interface 211 controls the construction of the graphical elements comprising the tables on the display of the user terminal 202. The synchronized scrolling routine is implemented as a function that couples a reference portion (e.g., the channel number) of a defined pair or group of attribute lists. Thus a scrolling action performed on one table will trigger the identical operation on the coupled table. If the coupled tables are not originally aligned, such as with respect to channels being displayed, a pre-synchronization function first aligns the second table to the first table, so that synchronized scrolling operation is performed with respect to the same reference. In an alternative embodiment, the tables for a particular WDM span are always synchronized relative to one another, thus pre-synchronization is not required in this case.

Although the scrolling function buttons were illustrated in a certain position and orientation in FIGS. 7 and 8, it should be noted that various alternative positions are possible with relation to the attribute tables. For example, the scroll function buttons can be placed alongside each table in a different position, or a single set of scroll buttons can be provided for two or more tables.

The embodiments illustrated in FIGS. 7 and 8 illustrate the capture and display of wavelength and performance attributes at a specific period of time. In an alternative embodiment of the present invention, this data can be captured at various or periodic points in time to provide a histogram analysis for the particular attributes. This allows the user to determine if there are any time-based effects related to the variations in wavelength and/or performance attributes of the network.

In the foregoing, a wavelength management system and graphical user interface for tracing and displaying wavelength and performance characteristics in a fiber optic network has been described. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A graphical user interface system for displaying one or more performance characteristics associated with a network span coupling a first network element to a second network element, the system comprising:
a first display area displaying a performance characteristic related to transmission of a signal over a transmission channel of the first network element in the network span to a reception channel of the second network element in the network span; and
a second display area displaying a counterpart performance characteristic for the reception channel of the second network element, wherein the counterpart performance characteristic measures a change in the performance characteristic after transmission of the signal over the network span.

2. The system of claim 1 wherein the network span comprises an optical network span employing Wavelength Division Multiplexing techniques for transmission of the signal between the first network element and the second network element in the network span.

3. The system of claim 2 wherein the performance characteristic comprises a wavelength of the signal transmitted over the transmission channel, and the counterpart performance characteristic comprises a wavelength of the signal received over the reception channel.

4. The system of claim 2 wherein the performance characteristic comprises a frequency of the signal transmitted over the transmission channel, and the counterpart performance characteristic comprises a frequency of the signal received over the reception channel.

5. The system of claim 2 wherein the performance characteristic comprises an optical power level of the signal transmitted over the transmission channel, and the counterpart performance characteristic comprises an optical power level of the signal received over the reception channel.

6. The system of claim 2 wherein the performance characteristic comprises an optical signal noise ratio of the signal transmitted over the transmission channel, and the counterpart performance characteristic comprises an optical signal noise ratio of the signal received over the reception channel.

7. The system of claim 1 further comprising:
a third display area displaying the performance characteristic graphically as a first function of time; and
a fourth display area displaying the counterpart performance characteristic as a second function of time.

8. The system of claim 1 wherein the first display area vertically displays a plurality of transmission channels each associated with a corresponding performance characteristic, and the second display area vertically displays a plurality of reception channels each associated with a corresponding counterpart performance characteristic.

9. The system of claim 8 further comprising:
a synchronization function correlating a display of the transmission channels within the first display area with a display of the reception channels in the second display area; and
a scrolling function configured to scroll the display of the reception channels in the second display area in accordance with user scrolling of the display of the transmission channels in the first display area.

10. The system of claim 8 further comprising a link tracing function configured to determine an identity of the second network element and an identity of the reception channel of the second network element in accordance with the transmission channel of the first network element to establish an identity of the network span.

11. The system of claim 1 wherein the first network element comprises an origination terminal site and the second network element comprises a destination terminal site, and wherein the network span comprises one or more amplifier stages disposed between the origination termination site and the destination termination site.

12. The system of claim 1 wherein the first network element comprises an origination terminal site and the second network element comprises an adjacent destination terminal site.

13. A network management device for tracing and displaying one or more performance characteristics associated with a network span coupling a first network element to a second network element, the device comprising:
means for displaying, in a first display area, a performance characteristic related to transmission of a signal over a transmission channel of the first network element to a reception channel of the second network element; and
means for displaying, in a second display area, a counterpart performance characteristic for the reception channel of the second network element, wherein the counterpart performance characteristic measures a change in the performance characteristic after transmission of the signal over the network span.

14. The device of claim 13 wherein the network span comprises an optical network span employing Wavelength Division Multiplexing techniques for transmission of the signal between the first network element and the second network element.

15. The device of claim 14 wherein the performance characteristic comprises a wavelength of the signal transmitted over the transmission channel, and the counterpart performance characteristic comprises a wavelength of the signal received over the reception channel.

16. The device of claim 14 wherein the performance characteristic comprises a frequency of the signal transmitted over the transmission channel, and the counterpart performance characteristic comprises a frequency of the signal received over the reception channel.

17. The device of claim 14 wherein the performance characteristic comprises an optical power level of the signal transmitted over the transmission channel, and the counterpart performance characteristic comprises an optical power level of the signal received over the reception channel.

18. The device of claim 13 further comprising:
means for displaying, in a third display area, the performance characteristic graphically as a first function of time; and
means for displaying, in a fourth display area, the counterpart performance characteristic as a second function of time.

19. The device of claim 13 wherein the first display area vertically displays a plurality of transmission channels each associated with a corresponding performance characteristic, and the second display area vertically displays a plurality of reception channels each associated with a corresponding counterpart performance characteristic.

20. The device of claim 19 further comprising:
synchronization means for correlating a display of the transmission channels within the first display area with a display of the reception channels in the second display area; and
scrolling means for scrolling the display of the reception channels in the second display area in accordance with user scrolling of the display of the transmission channels in the first display area.

21. The device of claim 20 further comprising a link tracing means for determining an identity of the second network element and an identity of the reception channel of the second network element in accordance with the transmission channel of the first network element to establish an identity of the network span.

22. The device of claim 13 wherein the network span comprises a portion of a Synchronous Optical Network.

23. The device of claim 13 wherein the network span comprises a portion of a Synchronous Digital Hierarchy network.

24. The device of claim 13 wherein the first network element comprises an origination terminal site and the second network element comprises a destination terminal site, and wherein the network span comprises one or more amplifier stages disposed between the origination termination site and the destination termination site.

25. The device of claim 13 wherein the first network element comprises an origination terminal site and the second network element comprises an adjacent destination terminal site.

26. A network management system for displaying one or more performance characteristics associated with a network span coupling a first network element to a second network element, the system comprising:
a first graphical user interface display area displaying a performance characteristic related to transmission of a signal over a transmission channel of the first network element to a reception channel of the second network element, the first display area vertically displaying a plurality of transmission channels each associated with a corresponding performance characteristic;
a second graphical user interface display area displaying a counterpart performance characteristic for the reception channel of the second network element, wherein the counterpart performance characteristic measures a change in the performance characteristic after transmission of the signal over the network span, the second display area vertically displaying a plurality of reception channels each associated with a corresponding counterpart performance characteristic; and
a synchronization function correlating a display of the transmission channels within the first display area with a display of the reception channels in the second display area; and
a scrolling function configured to scroll the display of the reception channels in the second display area in accordance with user scrolling of the display of the transmission channels in the first display area.

27. The system of claim 26 wherein the network span comprises an optical network span employing Wavelength Division Multiplexing techniques for transmission of the signal between the first network element and the second network element.

28. The system of claim 27 wherein the performance characteristic comprises a wavelength of the signal transmitted over the transmission channel, and the counterpart performance characteristic comprises a wavelength of the signal received over the reception channel.

29. The system of claim 27 wherein the performance characteristic comprises a frequency of the signal transmitted over the transmission channel, and the counterpart performance characteristic comprises a frequency of the signal received over the reception channel.

30. The system of claim 27 wherein the performance characteristic comprises an optical power level of the signal transmitted over the transmission channel, and the counterpart performance characteristic comprises an optical power level of the signal received over the reception channel.

31. The system of claim 27 wherein the performance characteristic comprises an optical noise ratio of the signal transmitted over the transmission channel, and the counterpart performance characteristic comprises an optical signal noise ratio of the signal received over the reception channel.

32. The system of claim 27 further comprising:
a third display area displaying the performance characteristic graphically as a first function of time; and
a fourth display area displaying the counterpart performance characteristic as a second function of time.

33. The system of claim 26 further comprising a link tracing function configured to determine an identity of the second network element and an identity of the reception channel of the second network element in accordance with the transmission channel of the first network element to establish an identity of the network span.

34. The system of claim 26 wherein the network span comprises a portion of a Synchronous Optical Network.

35. The system of claim 26 wherein the network span comprises a portion of a Synchronous Digital Hierarchy network.

36. A graphical user interface system for displaying one or more performance characteristics associated with a network span coupling a first network element to a second network element, the system comprising:
a first display area displaying a performance characteristic related to transmission of a signal in one direction from a first network element in the network span to a second network element in the network span; and
a second display area displaying a counterpart performance characteristic for the reception of the signal in a reverse direction with respect to the first network element, wherein the counterpart performance characteristic measures a change in the performance characteristic after transmission of the signal over the network span.

37. The system of claim 36 wherein the network span comprises an optical network span employing Wavelength division Multiplexing techniques for transmission of the signal between the first network element and the second network element in the network span.

38. The system of claim 37 wherein the performance characteristic comprises a wavelength of the signal transmitted over the transmission channel, and the counterpart performance characteristic comprises a wavelength of the signal received over the reception channel.

39. The system of claim 37 wherein the performance characteristic comprises a frequency of the signal transmitted over the transmission channel, and the counterpart performance characteristic comprises a frequency of the signal received over the reception channel.

40. The system of claim 37 wherein the performance characteristic comprises an optical power level of the signal transmitted over the transmission channel, and the counterpart performance characteristic comprises an optical power level of the signal received over the reception channel.

41. The system of claim 37 wherein the performance characteristic comprises an optical signal ratio of the signal transmitted over the transmission channel, and the counterpart performance characteristic comprises an optical signal ratio of the signal received over the reception channel.

42. The system of claim 36 further comprising:
a third display area displaying the performance characteristic graphically as a first function of time; and
a fourth display area displaying the counterpart performance characteristic as a second function of time.
